(19) United States
(12) Patent Application Publication
(10) Pub. No.: US 2005/0259149 A1
(43) Pub. Date: Nov. 24, 2005

(54) Surveillance system with acoustically augmented video monitoring

(76) Inventors: Paris Smaragdis, Brookline, MA (US); Bhiksha Ramakrishnan, Watertown, WA (US)

Correspondence Address: Patent Department;Mitsubishi Electric Research Laboratories, Inc., 201 Broadway, Cambridge, MA, 02139, US

(21) Appl. No.: 10/852,382

(22) Filed: May 24, 2004

(51) Int. Cl. H04N 7/18

(52) U.S. Cl. 348/143

(57) ABSTRACT

A system and method includes visualizing acoustic activity, or its detected features, and displaying the acoustic activity as visual signals alongside videos acquired by cameras. Either through use of simple signal processing, or through use of more sophisticated audio analysis or sound recognition, useful information can be extracted from acoustic signals. The extracted information can be transformed to visual signals superimposed on the video signals acquired by the cameras.

### FIELD OF THE INVENTION

The present invention relates generally to processing video signals and acoustic signals, and more particularly to augmenting video signals with the acoustic signals in surveillance systems.

### BACKGROUND OF THE INVENTION

In a typical surveillance system, a user, typically a security guard, monitors various locations via monitors connected to cameras. Visual monitoring of the locations provides information about activities at the locations, e.g., the movement of people and vehicles, and conditions of the environment.

In order to perform adequate surveillance and to respond to significant activities, the user typically needs to see some motion at the location. However, that method of surveillance monitoring can be inadequate in various situations.

Due to economic constraints, such systems have a limited range of view of each location because the cameras are either focused at a fixed location, or swivel along predetermined arcs. That can result in ‘blind’ spots, which can cause a misinterpretation, intentionally or unintentionally, of what is happening at a particular location. In addition, just the visual information by itself may not convey sufficient information to trigger intervention in response to unusual events.

To further illustrate the shortcomings of conventional surveillance systems, consider a few examples: A camera is located in a corridor outside an electrical service room. A minor explosion occurs in a transformer in the room. Visual cues are not available until smoke and flames spread from the room to the corridor. At that point, an alert may be too late. Similarly, a camera monitoring a parking lot at night, under snowy conditions, may be unable to detect a break-in or assault.

It is also possible that a camera is deliberately tampered with, making it useless for its intended purpose.

In all of the above examples, additional information, such as audio signals acquired by a microphone near a camera, could alert the user. That solution could suffice for a surveillance system with a single camera. However, for a system with many cameras, for example, tens or hundreds, being monitored by fewer users than cameras, instead of enhancing the surveillance, the multiple overlapping audio signals would result in nothing but an undecipherable cacophony.

Therefore, there is a need for augmenting video signals with acoustic signals that enhance the video signals.

### SUMMARY OF THE INVENTION

A system and method according to the invention includes visualizing acoustic activity, or its detected features, and displaying the acoustic activity as visual signals alongside videos acquired by cameras.

Either through use of simple signal processing, or through use of more sophisticated audio analysis or sound recognition, useful information can be extracted from acoustic signals. The extracted information can be transformed to visual signals superimposed on the video signals acquired by the cameras.

### BRIEF DESCRIPTION OF THE DRAWINGS

FIG. 1 is block diagram of a surveillance system according to the invention;

FIGS. 2 and 3 show images that are visually augmented by their corresponding acoustic signals.

### DETAILED DESCRIPTION OF THE PREFERRED EMBODIMENTS

System Structure

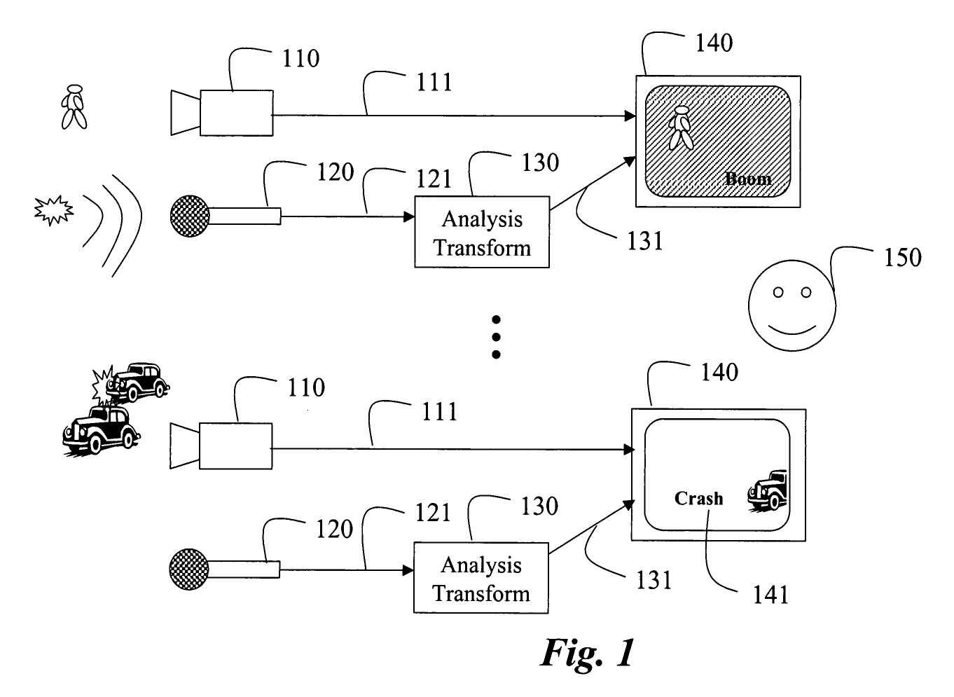

FIG. 1 shows a surveillance system 100 according to the invention. The system includes a set of cameras 110 for acquiring video signals 111. Associated with each camera is a microphone 120 for acquiring acoustic signals 121.

The audio signals 121, from each microphone, are analyzed and transformed by, e.g., a sound recognition module 130, to a visual signal 131. The visual signals 131 is combined with the video signals 111, and displayed on a corresponding monitor 140, to be viewed by a user 150. The visual signal can alter a brightness or color of the display, as indicated by shading in FIG. 1. Alternatively, the visual signal can be in the form of an icon or text 141.

System Operation

Sound Energy Visualization

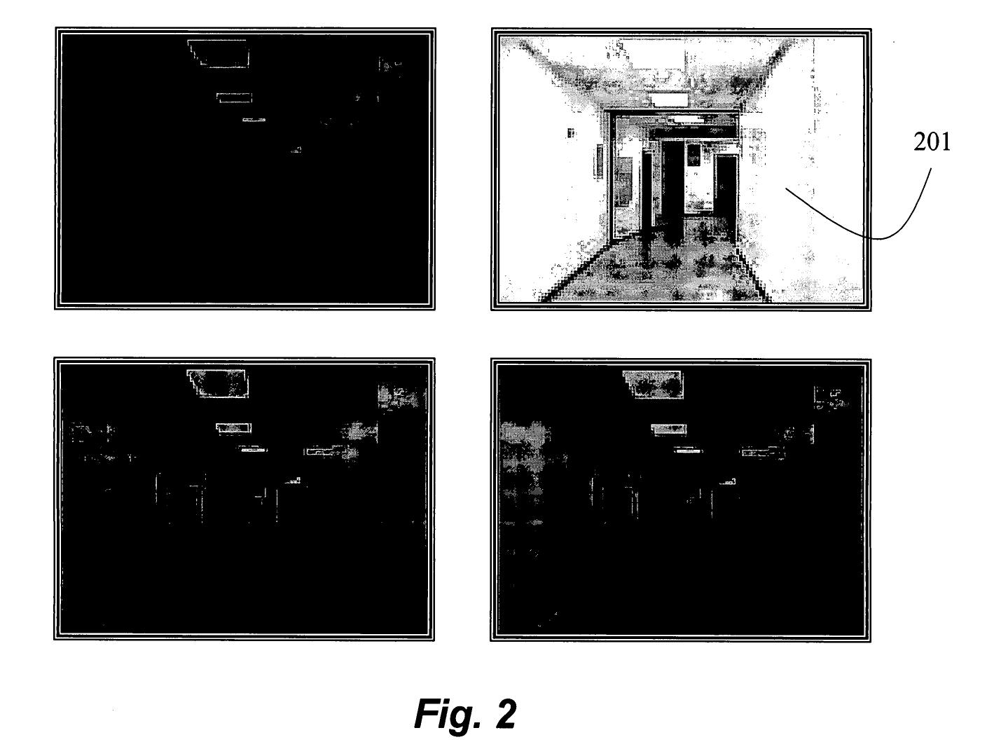

In many cases, the level of energy of the acoustic signal is sufficient to indicate an unusual event at a location. Take the case of a secure corridor, as shown in FIG. 2. Although visual activity can signify the presence of people, the angle of view of the camera may not cover the entire area under surveillance. Monitoring levels of acoustic activity and translating the acoustic signals to a corresponding brightness level of the displayed videos results in an array of monitors in which some images are brighter than other images. The brighter images signify higher sound levels, indicating, e.g., the presence of people at a location. Examining this array of monitors, the user is drawn naturally to inspect the monitor 201 that is associated with a greater level of activity.

Specific Sound Detection

It is also possible to train the analysis and transformation module 130 to detect and identify specific acoustic signals, such as doors opening and closing, screams, foot steps, running, etc. Identified acoustic signals can be displayed visually as an intensity level on a monitor, as an icon, or as text. The color of the display can also change from a normal gray scale, to a display that is colored red or yellow.

Spatial Information Visualization

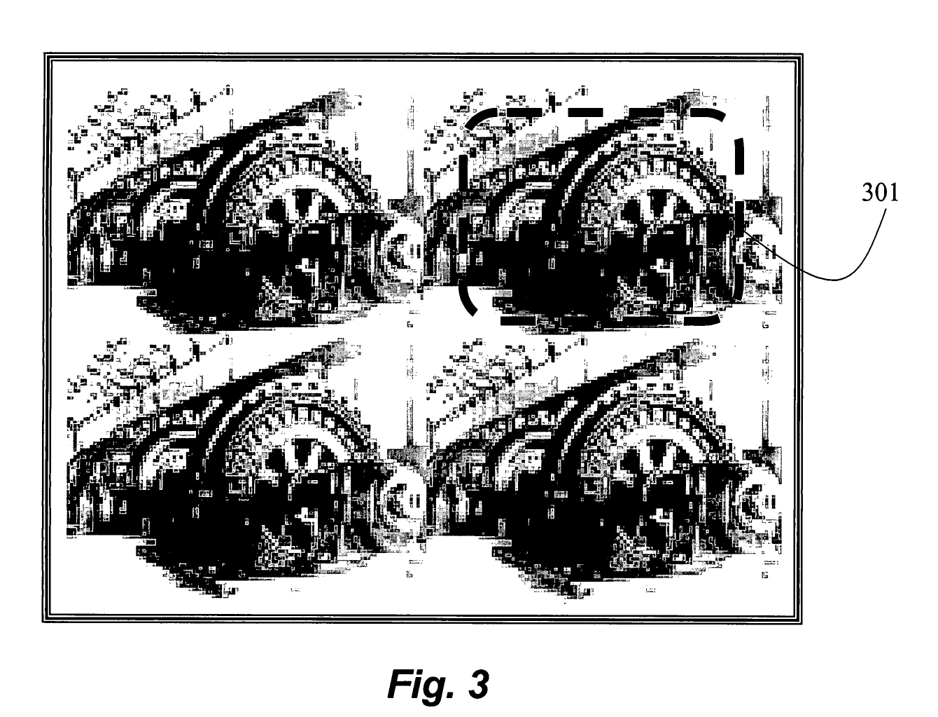

By using an array of microphones, it is possible to perform sound localization to assist the user, as shown in FIG. 3. Here, a bank of generators is being monitored. If one of the generators malfunctions, as indicated by rattling or screeching, then an area 301, which is a source of the unusual sounds, can be indicated.

Effect of the Invention

A system and method visually represents acoustic signals alongside video signals. The acoustic signals are analyzed and transformed to visual signals, which can be superimposed or otherwise displayed along with the video signals. The invention does not require extensive alterations of surveillance systems because most modern cameras are equipped with microphones.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. A surveillance system, comprising:
a set of cameras, each camera configured to acquire a video of an associated location;
a set of microphones, there being one microphone for each corresponding camera, each microphone configured to acquire an acoustic signal generated at the associated location;
means to analyze each acoustic signal, and to transform the acoustic signal to a visual signal;
a set of monitors, there being one monitor for each microphone and corresponding camera, each monitor configured to display concurrently the video and the visual signal.

2. The system of claim 1, in which the visual signal is text displayed on the monitor.

3. The system of claim 1, in which the visual signal is a color of images displayed on the monitor.

4. The system of claim 1, in which the visual signal is an icon displayed on the monitor.

5. The system of claim 1, in which the visual signal is an intensity of images displayed on the monitor.

6. The system of claim 5, in which the intensity corresponds to an energy of the acoustic signal.

7. The system of claim 1, in which the visual signal corresponds to a location of a source of the acoustic signal.

8. A surveillance method, comprising:
acquiring a set of videos with a set of cameras;
acquiring a set of acoustic signals with a set of microphones, there being one microphone for each corresponding camera;
analyzing each acoustic signal, and transforming the acoustic signal to a visual signal; and
displaying concurrently the video and the visual signal on an associated monitor.
